(19) United States
(12) Patent Application Publication
(10) Pub. No.: US 2023/0070732 A1
(43) Pub. Date: Mar. 9, 2023

(54) STORAGE BATTERY SEALING MEMBER AND STORAGE BATTERY INCLUDING THE SAME

(71) Applicant: UCHIYAMA MANUFACTURING CORP., Okayama (JP)

(72) Inventors: Otone ESUMI, Okayama (JP); Chihiro OHMORI, Okayama (JP); Yuji YASUFUKU, Okayama (JP); Takami KAWABATA, Okayama (JP)

(21) Appl. No.: 17/815,654

(22) Filed: Jul. 28, 2022

(30) Foreign Application Priority Data
Aug. 19, 2021 (JP) 2021-134331

(51) Int. Cl. H01M 50/193; H01M 50/198

(52) U.S. Cl. CPC H01M 50/193; H01M 50/198

(57) ABSTRACT

A storage battery sealing member includes a vulcanized rubber composition; the rubber composition contains a silicone rubber and a vulcanizing agent; a hardness Ha of the sealing member at 23° C. and a relative humidity of 50%, is 90 points or less; a compression set of the sealing member, measured after 25% compression followed by aging at 150° C. for 70 hours, is 80% or less; a difference between the hardness Ha of the sealing member at 23° C. and the relative humidity of 50% and a hardness Hb of the sealing member at 23° C. and the relative humidity of 50% after heated at 400° C. for 10 minutes is within 15 points; and a mass of a residue after heating the sealing member at 800° C. for 5 minutes, relative to the sealing member before heating, is 70 to 100% by mass.

### CROSS-REFERENCE TO RELATED APPLICATION

This application claims priority from Japanese Patent Application No. 2021-134331 filed with the Japan Patent Office on Aug. 19, 2021, the entire content of which is hereby incorporated by reference.

### BACKGROUND

### 1. Technical Field

An embodiment of the present disclosure relates to a storage battery sealing member and a storage battery including the sealing member.

### 2. Related Art

Various storage batteries represented by a lithium ion battery are sometimes subject to thermal runaway because of internal shorts and others, which causes ignition.

A known method for suppressing spread of ignition from cells and the like to other cells and the like is a method for separating cells housed in a container from each other by a fire-resistant sheet or the like (see JP-A-2019-131654 and JP-T-2020-532078). However, the ignition spread suppression effect of this method is insufficient, and ignition has often spread to the entire storage battery once cells and the like have ignited. Thus, there is demand for a method for suppressing ignition spread to the entire storage battery even when ignition occurs and minimizing damage.

### SUMMARY

A storage battery sealing member includes a vulcanized rubber composition, and the rubber composition contains a silicone rubber and a vulcanizing agent. A hardness Ha of the sealing member measured by a durometer type A at 23° C. and a relative humidity of 50%, is 90 points or less. A compression set of the sealing member, measured after 25% compression followed by aging at 150° C. for 70 hours in accordance with JIS K6262, is 80% or less. A difference between the hardness Ha of the sealing member measured by the durometer type A at 23° C. and the relative humidity of 50% and a hardness Hb of the sealing member measured by the durometer type A at 23° C. and the relative humidity of 50% after heated at 400° C. for 10 minutes is within 15 points. A mass of a residue after heating the sealing member at 800° C. for 5 minutes, relative to the sealing member before heating, is 70 to 100% by mass.

### BRIEF DESCRIPTION OF DRAWINGS

FIGURE illustrates an example of a cross-sectional schematic view of a storage battery according to one embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a storage battery sealing member which is suitably used for, for example, suppressing ignition spread.

The problem described above is solved by a storage battery sealing member (the present storage battery sealing member) as follows. The storage battery sealing member includes a vulcanized rubber composition, and the rubber composition contains a silicone rubber and a vulcanizing agent. A hardness Ha of the sealing member measured by a durometer type A at 23° C. and a relative humidity of 50%, is 90 points or less. A compression set of the sealing member, measured after 25% compression followed by aging at 150° C. for 70 hours in accordance with JIS K6262, is 80% or less. A difference between the hardness Ha of the sealing member measured by the durometer type A at 23° C. and the relative humidity of 50% and a hardness Hb of the sealing member measured by the durometer type A at 23° C. and the relative humidity of 50% after heated at 400° C. for 10 minutes is within 15 points. A mass of a residue after heating the sealing member at 800° C. for 5 minutes, relative to the sealing member before heating, is 70 to 100% by mass.

A storage battery according to one embodiment of the present disclosure (the present storage battery) includes: a container; a plurality of cells housed in the container; a heat insulating plate that separates the cells from each other; and the present storage battery sealing member which seals a gap between the container and the heat insulating plate.

The present storage battery sealing member is high in flame retardancy and, further, unlikely to lose sealing properties even when heated at high temperature. Therefore, use of the present storage battery sealing member to seal, for example, a gap between a container and a heat insulating plate in a storage battery enables effective suppression of ignition spread to the entire storage battery even when cells and the like ignite. Accordingly, the present storage battery including the present storage battery sealing member also has high safety.

A storage battery sealing member according to one embodiment of the present disclosure (the present sealing member) includes a vulcanized rubber composition, and the rubber composition contains a silicone rubber and a vulcanizing agent. A hardness Ha of the present sealing member measured by a durometer type A at 23° C. and a relative humidity of 50%, is 90 points or less. A compression set of the present sealing member, measured after 25% compression followed by aging at 150° C. for 70 hours in accordance with JIS K6262, is 80% or less. A difference between the hardness Ha of the present sealing member measured by the durometer type A at 23° C. and the relative humidity of 50% and a hardness Hb of the present sealing member measured by the durometer type A at 23° C. and the relative humidity of 50% after heated at 400° C. for 10 minutes is within 15 points. A mass of a residue after heating the present sealing member at 800° C. for 5 minutes, relative to the present sealing member before heating, is 70 to 100% by mass.

The present sealing member is high in flame retardancy and, further, unlikely to lose sealing properties even when heated at high temperature. Therefore, use of the present sealing member to seal, for example, a gap between a container and a heat insulating plate in a storage battery enables effective suppression of ignition spread to the entire storage battery even when cells and the like ignite.

The silicone rubber is not particularly limited. The silicone rubber to be suitably used is high in flame retardancy and fire resistance. Examples of the silicone rubber include “KE-5620BL-U”, “KE-5612E-U”, “KE-5620W-U”, and “KE-1734-U”, which are a silicone rubber manufactured by Shin-Etsu Chemical Co., Ltd., “SILASTIC SH502U” and “SILASTIC SH1447”, which are a silicone rubber manufactured by Dow Toray Co., Ltd., and “TCM5406U”, “TSE2183UN”, and “TSE2187U”, which are a silicone rubber manufactured by Momentive Performance Materials Japan LLC.

The content of the silicone rubber in the rubber composition is usually 50% by mass or more, preferably 60% by mass or more, more preferably 70% by mass or more, and further preferably 80% by mass or more.

The vulcanizing agent contained in the rubber composition is not particularly limited and appropriately selected depending on a vulcanization method. An example of the vulcanizing agent used for peroxide vulcanization is a vulcanizing agent containing organic peroxide such as benzoyl peroxide, tertiary butyl perbenzoate, ortho methylbenzoyl peroxide, para methylbenzoyl peroxide, ditertiary butyl peroxide, dicumyl peroxide, 1,1-bis(tertiary butyl peroxy)3,3,5-trimethyl cyclohexane, 2,5-dimethyl-2,5-di(tertiary butyl peroxy)hexane, and 2,5-dimethyl-2,5-di(tertiary butyl peroxy)hexyne. An example of the vulcanizing agent used for addition vulcanization is a platinum catalyst.

The content of the vulcanizing agent in the rubber composition is preferably 0.05 to 5% by mass. When the content is less than 0.05% by mass, the hardness of the obtained present sealing member maybe excessively low. The content is more preferably 0.1% by mass or more. On the other hand, when the content of the vulcanizing agent exceeds 5% by mass, the obtained present sealing member may be excessively hard resulting in deformation of a partner member and decrease in sealing properties. The content is more preferably 2% by mass or less and further preferably 1.5% by mass or less.

From the viewpoint of processability of the rubber composition, the rubber composition preferably contains oil. The oil is preferably silicone oil. The silicone oil is preferably modified silicone oil. Examples of the modified silicone oil include silicone oils modified with amino, epoxy, carboxyl, carbinol, (meth)acryl, mercapto, phenol, polyether, methylstyryl, alkyl, higher fatty acid ester, higher alkoxy, fluorine, aralkyl, and the like. These modified silicone oils are classified into non-reactive and reactive. Especially, non-reactive modified silicone oils are preferable. The content of the oil in the rubber composition is preferably 0.1 to 15% by mass. When the content is less than 0.1% by mass, processability of the rubber composition may decrease. The content is more preferably 0.3% by mass or more and further preferably 0.5% by mass or more. On the other hand, when the content of the oil exceeds 15% by mass, the rubber composition may be excessively soft or subject to bleeding. The content is more preferably 10% by mass or less and further preferably 5% by mass or less.

The rubber composition may contain a flame retardant or the like. Examples of the flame retardant include iron oxide, a triazole-based compound, aluminum hydroxide, platinum, and a platinum compound. Among these, a platinum compound is preferable. It is noted that, for example, when the rubber composition contains a platinum compound, the content is usually 1 to 5000 ppm.

The rubber composition may contain additives, other than the silicone rubber, the vulcanizing agent, the flame retardant, and the oil, as long as the effects of the present sealing member are not inhibited.

The production method of the present sealing member is not particularly limited. A suitable production method includes a kneading process of kneading the silicone rubber and the vulcanizing agent, as well as, as necessary, the oil, the flame retardant, and other additives to obtain the rubber composition, a molding process of molding the rubber composition, and a vulcanizing process of vulcanizing the obtained molded product.

In the kneading process, a method for mixing the ingredients is not particularly limited. The kneading can be performed using an open roll, a kneader, a Banbury mixer, an intermixer, an extruder, and the like. Among these, an open roll is preferably used for kneading. The temperature in kneading is preferably 20 to 100° C.

Examples of the molding method of the rubber composition include injection molding, extrusion molding, compression molding, and roll molding. Among these, injection molding and compression molding are suitable. The vulcanization may be performed after the rubber composition is previously molded or may be performed simultaneously with the molding. The vulcanization temperature is usually 100 to 200° C. The vulcanization time is usually 0.1 to 60 minutes. A heating method for vulcanization to be used is a common method used for the vulcanization of silicone rubber, such as compression heating, steam heating, oven heating, or hot air heating. Secondary vulcanization may be further performed. In such a case, the vulcanization temperature is usually 150 to 200° C., and the vulcanization time is usually 1 to 4 hours.

In this manner, the present sealing member is obtained. The compression set of the present sealing member is measured after 25% compression followed by aging at 150° C. for 70 hours in accordance with JIS K6262. The measured compression set is preferably 80% or less. When the compression set is 80% or less, sealing properties of the present sealing member are enhanced. This can effectively suppress ignition spread. The compression set is preferably 65% or less, more preferably 50% or less, further preferably 40% or less, and particularly preferably 30% or less. On the other hand, the compression set is usually 1% or more.

A hardness Ha (measured by the durometer type A) of the present sealing member at 23° C. and a relative humidity of 50% is preferably 90 points or less. When the hardness Ha (measured by the durometer type A) is 90 points or less, the surface pressure to a partner surface is maintained, and sealing properties of the present sealing member increase. This can effectively suppress ignition spread. The hardness Ha (measured by the durometer type A) is preferably 85 points or less and more preferably 80 points or less. On the other hand, from the viewpoint of further enhancing sealing properties, the hardness Ha (measured by the durometer type A) is preferably 30 points or more, more preferably 35 points or more, and further preferably 40 points or more. The hardness Ha (measured by the durometer type A) of the present sealing member is measured by a method described in Examples described later.

In the present embodiment, a difference between the hardness Ha (measured by the durometer type A) of the present sealing member at 23° C. and the relative humidity of 50% and a hardness Hb (measured by the durometer type A) of the present sealing member at 23° C. and the relative humidity of 50% after heated at 400° C. for 10 minutes is preferably within 15 points. When the difference is within 15 points, sealing properties of the present sealing member when ignition occurs are unlikely to decrease. This can effectively suppress ignition spread. On the other hand, the difference is sometimes ±0 but usually 1 point or more. As long as the difference is within 15 points, either the hardness Ha (measured by the durometer type A) of the present sealing member before heating or the hardness Hb (measured by the durometer type A) of the present sealing member after heating may be higher.

A mass of a residue after the present sealing member is heated at 800° C. for 5 minutes, relative to the present sealing member before heating, is preferably 70 to 100% by mass. Since this enables the shape of the present sealing member to be maintained even after the present sealing member is heated and decreased in sealing properties when ignition occurs, a certain ignition spread suppression effect is exerted. The mass of the residue is preferably 75% by mass or more and more preferably 78% by mass or more. The mass of the residue is calculated by a method described in Examples described later.

The present sealing member is unlikely to lose sealing properties even when heated and, further, maintains its shape even after sealing properties are lost.

Therefore, the present sealing member has an excellent ignition spread suppression effect. Thus, the present sealing member is suitably used as a sealing member for various storage batteries (secondary batteries) such as a lithium ion battery, a lithium ion polymer battery, a nickel-hydrogen battery, a lithium-sulfur battery, a nickel-cadmium battery, a nickel battery, a nickel-zinc battery, a sodium-sulfur battery, a lead storage battery, and an air battery. Among these, the present sealing member is more preferably used as a sealing member for lithium ion batteries which have high energy density and may be seriously damaged when ignition occurs.

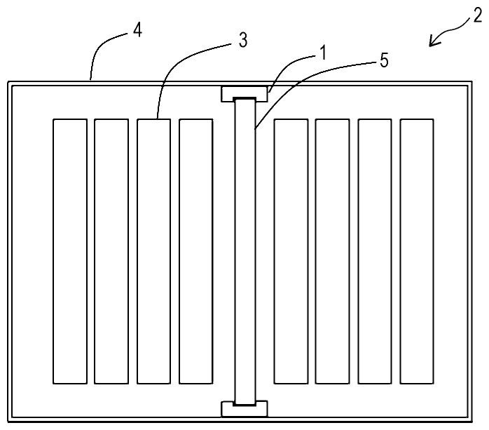

A storage battery 2 illustrated in FIG. 1s a suitable embodiment of the present disclosure. This storage battery 2 includes a sealing member 1 as the present sealing member. The storage battery 2 includes a container 4, a plurality of cells 3 housed in the container 4, a heat insulating plate 5 that separates the cells 3 from each other, and the sealing member 1 that seals a gap between the container 4 and the heat insulating plate 5. In the storage battery 2, a gap between the container 4 and the heat insulating plate 5 is sealed by the sealing member 1 for a purpose of suppressing ignition spread. FIGURE illustrates an example of a cross-sectional schematic view of the storage battery 2 according to the present embodiment. Hereinafter, the storage battery 2 according to the present embodiment will be described with reference to FIGURE.

The type of the storage battery 2 including the sealing member 1 is not particularly limited. Examples of a storage battery including the present sealing member are as described above. The shape of the cells 3 is not particularly limited and may be cylindrical, rectangular, or laminated. The cells 3 usually contain a sheathing member, as well as a positive electrode material, a negative electrode material, a separator, a positive electrode terminal, and a negative electrode terminal housed in the sheathing material.

The plurality of cells 3 is housed in the container 4. The shape of the container 4 is not particularly limited and may be rectangular or cylindrical. The cells 3 housed in the container 4 are separated from each other by the heat insulating plate 5. In FIGURE, the plurality of cells 3 housed in the container 4 is split into two by one heat insulating plate 5. However, the plurality of cells 3 housed in the container 4 may be split into three or more by two or more heat insulating plates 5. The type of the container 4 is not particularly limited. As the container 4, a metal container, a resin container, or the like is used. The type of the heat insulating plate 5 is also not particularly limited, as long as heat insulation and flame retardancy are high. As the heat insulating plate 5, a metal heat insulating plate 5, a resin heat insulating plate 5, or the like is used. The heat insulating plate 5 may have multiple types of plates joined on top of each other.

The sealing member 1 is disposed between the container 4 and the heat insulating plate 5. Sealing a gap between the container 4 and the heat insulating plate 5 by the sealing member 1 suppresses or delays spread of ignition to other cells 3 and the like separated by the heat insulating plate 5, even when the cells 3 and the like ignite. The sealing member 1 may be disposed at least part of a gap between the container 4 and the heat insulating plate 5. The sealing member 1 may be disposed at a site suitable for suppressing ignition spread in consideration of, for example, the design of the storage battery 2. The sealing member 1 is preferably disposed in a gap between the container 4 and the heat insulating plate 5, such that leaking of gas from one of spaces separated by the heat insulating plate 5 into the other is suppressed. A method therefor is, for example, a method of placing the sealing member 1 on the entire circumference of the heat insulating plate 5 and bringing the sealing member 1 and the container 4 into contact with each other. It is noted that the sealing member 1 may be placed on part of the circumference of the heat insulating plate 5, if ignition spread to other cells 3 and the like is suppressed or delayed. The shape of the sealing member 1 is not particularly limited and may be determined in consideration of the shapes of the heat insulating plate 5 and the container 4, the shape of a gap between the heat insulating plate 5 and the container 4, and the like. The sealing member 1 may include, for example, a pair of lip portions. The lip portions are used such that the sealing member 1 is contact-bonded, in an elastic deformed state, to the inner wall of the container 4. Since ignition spread to other cells 3 and the like separated by the heat insulating plate 5 is suppressed or delayed even when the cells 3 and the like ignite in the storage battery 2 of the present embodiment including the prescribed sealing member 1, the storage battery 2 has high safety.

### EXAMPLES

Hereinafter, the technology of the present disclosure will be further specifically described by examples.

### (Ordinary State Physical Properties)

Obtained three 2 mm-thick vulcanized rubber sheets stacked on one another were measured for hardness at 23° C. and a relative humidity of 50% using a durometer type A. A peak value obtained in this measurement was defined as the hardness of the vulcanized rubber sheets measured by the durometer type A.

### (Compression Set Test)

In accordance with JIS K6262 (150° C., 70 hours), a cylindrical test piece was compressed by 25% and aged in air at 150° C. for 70 hours. Thereafter, the compression was released, and a compression set in the test piece was calculated. It can be said that the smaller the value of the compression set, the higher the restoring force after compression for a long time in the test piece.

### (Burning Test)

Flame retardancy based on UL94 (Vertical Burning Test) was evaluated. According to 20 mm Vertical Burning Test (Method B of IEC60695-11-10, ASTM D3801), a strip sample of 125±5 mm in length, 13.0±0.5 mm in width, and 1 mm in thickness was vertically attached to a clamp. A 20 mm flame was applied to this strip sample for 10 seconds twice, and flame retardancy was evaluated based on the burning behaviors of the strip sample. It is noted that the strip sample was obtained by cutting out a vulcanized rubber sheet.

### (High Temperature Test)

A vulcanized rubber sheet was cut out to obtain a 30 mm square sample having a thickness of 2 mm. This sample was put in a crucible. The crucible was placed in an electric furnace set at 400° C., after increased in temperature, and removed after 10 minutes. Three vulcanized rubber sheets heated in this manner were stacked on one another. These three vulcanized rubber sheets stacked on one another were measured for hardness at 23° C. and a relative humidity of 50% using a durometer type A. A peak value obtained in this measurement was defined as the hardness of the vulcanized rubber sheets after heating, measured by the durometer type A.

A vulcanized rubber sheet was cut out to obtain a 20 mm square sample having a thickness of 2 mm. The mass of this sample was measured and thereafter put in a crucible. The crucible was placed in an electric furnace set at 800° C., after increased in temperature, and removed after 5 minutes. Thereafter, the mass of the sample (residue) was measured.

### Examples 1 to 7 and Comparative Examples 1 to 3

A mixture having a make-up illustrated in Table 1 was kneaded using an open roll at a temperature of 20 to 100° C. for 10 to 30 minutes, thereby to obtain a rubber composition. With this rubber composition, an unvulcanized rubber sheet was prepared. The obtained unvulcanized rubber sheet was press vulcanized at 165° C. for 10 minutes and thereafter subjected to secondary vulcanization at 200° C. for 4 hours. Accordingly, there was obtained a vulcanized rubber sheet having a thickness of 2 mm or 1 mm (hereinafter, sometimes simply referred to as a vulcanized rubber sheet). Also, a plurality of the unvulcanized rubber sheets stacked on one another was placed in a press molding die, and subjected to press vulcanization at 165° C. for 30 minutes followed by secondary vulcanization at 200° C. for 4 hours. Accordingly, there was obtained a cylindrical test piece with a diameter of 29.0 mm and a thickness of 12.5 mm for measuring compression set. The vulcanized rubber sheet and the test piece for measuring compression set were subjected to each measurement. The measurement result is illustrated in Table 1.

TABLE 1
<Rubber composition standard (mass %)>

| | | | | Example | Example | Example | Example | Example | Example |
|---|---|---|---|---|---|---|---|---|---|
| | | | | 1 | 2 | 3 | 4 | 5 | 6 |
| Rubber | Rubber | “KE-5620BL-U” flame | | 96.5 | 96.8 | | | | |
| composition | | retardant silicone rubber | | | | | | | |
| (mass %) | | manufactured by Shin-Etsu | | | | | | | |
| | | Chemical Co., Ltd. | | | | | | | |
| | | “KE-5612E-U” flame | | | | 98.7 | | | |
| | | retardant silicone | | | | | | | |
| | | rubber manufactured by Shin- | | | | | | | |
| | | Etsu Chemical Co., Ltd. | | | | | | | |
| | | “KE-1734-U” fire | | | | | 98.7 | | |
| | | resistant silicone rubber | | | | | | | |
| | | manufactured by Shin-Etsu | | | | | | | |
| | | Chemical Co., Ltd. | | | | | | | |
| | | “SH502U” flame retardant | | | | | | 99.5 | |
| | | silicone rubber manufactured | | | | | | | |
| | | by Dow Toray Co., Ltd. | | | | | | | |
| | | “SH1447” flame retardant | | | | | | | 97.6 |
| | | silicone rubber manufactured | | | | | | | |
| | | by Dow Toray Co., Ltd. | | | | | | | |
| | | “TSE2183UN” flame | | | | | | | |
| | | retardant silicone rubber | | | | | | | |
| | | manufactured by Momentive | | | | | | | |
| | | Performance Materials | | | | | | | |
| | | Japan LLC | | | | | | | |
| | | “KE-961-U” silicone | | | | | | | |
| | | rubber manufactured by | | | | | | | |
| | | Shin-Etsu Chemical Co., Ltd. | | | | | | | |
| | | “DAI-EL G-912” fluorine | | | | | | | |
| | | rubber manufactured by Daikin | | | | | | | |
| | | Industries, Ltd. | | | | | | | |
| | | “JSR EP24” ethylene | | | | | | | |
| | | propylene rubber manufactured | | | | | | | |
| | | by JSR Corporation | | | | | | | |
| | Oil | “KF-410” non-reactive | | 1.9 | 1.9 | | | | 2.0 |
| | | silicone oil manufactured | | | | | | | |
| | | by Shin-Etsu Chemical Co., | | | | | | | |
| | | Ltd. Modification type: | | | | | | | |
| | | aralkyl-modified | | | | | | | |
| | | Naphthene-based oil | | | | | | | |
| | Vulcan- | “C-3” flame retardant | | 1.3 | | 1.3 | | | |
| | izing | vulcanizing agent manufactured | | | | | | | |
| | agent | by Shin-Etsu Chemical Co., Ltd. | | | | | | | |
| | | “C-8” vulcanizing | | | | | | | |
| | | agent manufactured by | | | | | | | |
| | | Shin-Etsu Chemical Co., Ltd. | | | | | | | |
| | | “C-23N” vulcanizing | | | 1.3 | | 1.3 | | |
| | | agent manufactured by Shin- | | | | | | | |
| | | Etsu Chemical Co., Ltd. | | | | | | | |
| | | “RC4 50P” vulcanizing | | | | | | 0.5 | 0.4 |
| | | agent manufactured by Dow | | | | | | | |
| | | Toray Co., Ltd. | | | | | | | |
| | | “TC-8” manufactured by | | | | | | | |
| | | Momentive Performance | | | | | | | |
| | | Materials Japan LLC | | | | | | | |
| | | 2,5-dimethyl-2,5-di(t-butyl | | | | | | | |
| | | peroxy)hexane | | | | | | | |
| | | dicumyl peroxide | | | | | | | |
| | | “X-93-1609” flame | | 0.3 | | | | | |
| | | retardant promoter | | | | | | | |
| | | manufactured by Shin-Etsu | | | | | | | |
| | | Chemical Co., Ltd. | | | | | | | |
| | | Triallyl isocyanurate | | | | | | | |
| | Filler | N990 carbon | | | | | | | |
| | | HAF carbon | | | | | | | |
| Evaluation | Ordinary | Hardness (Shore A, pts.) | | 55 | 57 | 57 | 74 | 55 | 70 |
| | state | | | | | | | | |
| | High | 150° C., | Compression | 20 | 22 | 10 | 15 | 15 | 9 |
| | temperature | 70 h | set (%) | | | | | | |
| | test | 400° C., | Hardness | −6 | −1 | −12 | 5 | −3 | −12 |
| | | 10 min | change¹⁾ (PTS.) | | | | | | |
| | | 800° C., | Mass of | 80 | 82 | 82 | 83 | 74 | 85 |
| | | 5 min | residue²⁾ (mass %) | | | | | | |
| | Burning | 20 mm flame, | Burning behaviors | V-0 | V-0 | V-0 | — | V-0 | V-0 |
| | test | 10 sec, twice | | | | | | | |

| | | | Example | Comparative | Comparative | Comparative |
|---|---|---|---|---|---|---|
| | | | 7 | Example 1 | Example 2 | Example 3 |
| Rubber | Rubber | “KE-5620BL-U” flame | | | | |
| composition | | retardant silicone rubber | | | | |
| (mass %) | | manufactured by Shin-Etsu | | | | |
| | | Chemical Co., Ltd. | | | | |
| | | “KE-5612E-U” flame | | | | |
| | | retardant silicone | | | | |
| | | rubber manufactured by Shin- | | | | |
| | | Etsu Chemical Co., Ltd. | | | | |
| | | “KE-1734-U” fire | | | | |
| | | resistant silicone rubber | | | | |
| | | manufactured by Shin-Etsu | | | | |
| | | Chemical Co., Ltd. | | | | |
| | | “SH502U” flame retardant | | | | |
| | | silicone rubber manufactured | | | | |
| | | by Dow Toray Co., Ltd. | | | | |
| | | “SH1447” flame retardant | | | | |
| | | silicone rubber manufactured | | | | |
| | | by Dow Toray Co., Ltd. | | | | |
| | | “TSE2183UN” flame | 99.5 | | | |
| | | retardant silicone rubber | | | | |
| | | manufactured by Momentive | | | | |
| | | Performance Materials | | | | |
| | | Japan LLC | | | | |
| | | “KE-961-U” silicone | | 98.0 | | |
| | | rubber manufactured by | | | | |
| | | Shin-Etsu Chemical Co., | | | | |
| | | Ltd. | | | | |
| | | “DAI-EL G-912” fluorine | | | 79.7 | |
| | | rubber manufactured by Daikin | | | | |
| | | Industries, Ltd. | | | | |
| | | “JSR EP24” ethylene | | | | 61.5 |
| | | propylene rubber manufactured | | | | |
| | | by JSR Corporation | | | | |
| | Oil | “KF-410” non-reactive | | | | |
| | | silicone oil manufactured | | | | |
| | | by Shin-Etsu Chemical Co., | | | | |
| | | Ltd. Modification type: | | | | |
| | | aralkyl-modified | | | | |
| | | Naphthene-based oil | | | | 6.1 |
| | Vulcan- | “C-3” flame retardant | | | | |
| | izing | vulcanizing agent manufactured | | | | |
| | agent | by Shin-Etsu Chemical Co., Ltd. | | | | |
| | | “C-8” vulcanizing | | 2.0 | | |
| | | agent manufactured by | | | | |
| | | Shin-Etsu Chemical Co., Ltd. | | | | |
| | | “C-23N” vulcanizing | | | | |
| | | agent manufactured by Shin- | | | | |
| | | Etsu Chemical Co., Ltd. | | | | |
| | | “RC4 50P” vulcanizing | | | | |
| | | agent manufactured by Dow | | | | |
| | | Toray Co., Ltd. | | | | |
| | | “TC-8” manufactured | 0.5 | | | |
| | | by Momentive Performance | | | | |
| | | Materials Japan LLC | | | | |
| | | 2,5-dimethyl-2,5-di(t-butyl | | | 1.2 | |
| | | peroxy)hexane | | | | |
| | | dicumyl peroxide | | | | 1.7 |
| | | “X-93-1609” flame | | | 3.2 | |
| | | retardant promoter | | | | |
| | | manufactured by Shin-Etsu | | | | |
| | | Chemical Co., Ltd. | | | | |
| | | Triallyl isocyanurate | | | | |
| | Filler | N990 carbon | | | 15.9 | |
| | | HAF carbon | | | | 30.7 |
| Evaluation | Ordinary | Hardness (Shore A, pts.) | 54 | 60 | 70 | 60 |
| | state | | | | | |

| | | | | | | |
|---|---|---|---|---|---|---|
| High | 150° C., | Compression | 22 | 9 | 13 | 25 |
| temperature | 70 h | set (%) | | | | |
| test | 400° C., | Hardness | −10 | Unmeasurable | −13 | Unmeasurable |
| | 10 min | change¹⁾ (PTS.) | | | | |
| | 800° C., | Mass of | 73 | 47 | 1 or less | 1 or less |
| | 5 min | residue²⁾ (mass %) | | | | |
| Burning | 20 mm flame, | Burning | V-0 | Incompatible | V-0 | Incompatible |
| test | 10 sec, twice | behaviors | | | | |

¹⁾Hardness change = hardness of sample after heating - ordinary state hardness of sample before heating
²⁾Mass % of residue = mass of sample (residue) after heating/mass of sample before heating × 100

Also, the sealing member and storage battery according to the present embodiment may be respectively a first sealing member and a first storage battery described below.

The first sealing member is a storage battery sealing member obtained by vulcanizing a rubber composition, in which the rubber composition contains a silicone rubber and a vulcanizing agent, a hardness Ha (measured by a durometer type A) of the sealing member at 23° C. and a relative humidity of 50% is 90 points or less, a compression set of the sealing member, measured after 25% compression followed by aging at 150° C. for 70 hours in accordance with JIS K6262, is 80% or less, a difference between the hardness Ha (measured by the durometer type A) of the sealing member at 23° C. and the relative humidity of 50% and a hardness Hb (measured by the durometer type A) of the sealing member at 23° C. and the relative humidity of 50% after heated at 400° C. for 10 minutes is within 15 points, and a mass of a residue after heating the sealing member at 800° C. for 5 minutes, relative to the sealing member before heating, is 70 to 100% by mass.

The first storage battery is a storage battery including the first sealing member, in which a plurality of cells is housed in a container, the cells are separated from each other by a heat insulating plate, and a gap between the container and the heat insulating plate is sealed by the first sealing member for preventing ignition spread.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A storage battery sealing member, comprising a vulcanized rubber composition,
wherein the rubber composition contains a silicone rubber and a vulcanizing agent,
a hardness Ha of the sealing member measured by a durometer type A at 23° C. and a relative humidity of 50%, is 90 points or less,
a compression set of the sealing member, measured after 25% compression followed by aging at 150° C. for 70 hours in accordance with JIS K6262 is 80% or less,
a difference between the hardness Ha of the sealing member measured by the durometer type A at 23° C. and the relative humidity of 50% and a hardness Hb of the sealing member measured by the durometer type A at 23° C. and the relative humidity of 50% after heated at 400° C. for 10 minutes is within 15 points, and
a mass of a residue after heating the sealing member at 800° C. for 5 minutes, relative to the sealing member before heating, is 70 to 100% by mass.

2. A storage battery, comprising:
a container;
a plurality of cells housed in the container;
a heat insulating plate that separates the cells from each other; and
the storage battery sealing member according to claim 1, which seals a gap between the container and the heat insulating plate.
